(19) United States
(12) Patent Application Publication
(10) Pub. No.: US 2008/0037537 A1
(43) Pub. Date: Feb. 14, 2008

(54) METHOD AND SYSTEM FOR TRAVERSING NETWORK ADDRESS TRANSLATION OR FIREWALL DEVICE

(75) Inventors: Xin YAO, Guangdong (CN); Liedan JU, Guangdong (CN)

Correspondence Address: SUGHRUE MION, PLLC, 2100 PENNSYLVANIA AVENUE, N.W., SUITE 800, WASHINGTON, DC, 20037, US

(73) Assignee: HUAWEI TECHNOLOGIES CO., LTD., Guangdong (CN)

(21) Appl. No.: 11/867,948

(22) Filed: Oct. 5, 2007

Related U.S. Application Data
(63) Continuation of application No. PCT/CN2006/001069, filed on May 23, 2006.

(30) Foreign Application Priority Data
May 23, 2005 (CN) 200510072499.8

(51) Int. Cl. H04L 12/56

(52) U.S. Cl. 370/389

(57) ABSTRACT

The present invention discloses a method for traversing Network Address Translation (NAT) or Firewall (FW) devices, including: setting up a User Datagram Protocol (UDP) tunnel between a first device and a second device, wherein the first device and the second device are on the two sides of the NAT or FW device; and transmitting, via the UDP tunnel, a packet originated from one of the two devices to the other of the two devices through the NAT or FW device. With the method provided in the present invention, packets can traverse the NAT or FW device without any modification to the NAT or FW device.

### FIELD OF THE INVENTION

The present invention relates to communication technologies, and particularly, to a method and system for traversing a Network Address Translation (NAT) or Firewall (FW) device.

### BACKGROUND OF THE INVENTION

In recent years, mobile communication has become one of the fields with severest competition, and telecommunication operators should provide more and more differentiated services to promote their competitiveness. The Next Generation Network (NGN), owing to its ability to provide broad application prospect and satisfy diversified and customized service requirements, has been the focus of the field, where soft switching and packet switching technologies are core technologies of the NGN.

At present, the NGN encounters many problems in applications, e.g., in user access. Users access the NGN based on a packet network via Internet Protocol (IP) addresses. On account of such as short supply of IP addresses and security problem, a lot of enterprise networks and customer premise networks adopt private IP addresses to access a public network via NAT or FW devices equipped at an egress.

The most distinguished advantage of the NGN is that the NGN can provide users with varieties of services, especially IP Centrex service integrating voice, data and audio services for enterprise users. It is expected that all network applications should communicate with others in a standard mode, i.e., all network applications communicate with others by using the IP addresses in packet headers. Therefore, a control channel or media channel for bearing such audio or video protocol over the IP as H.323, Session Initiation Protocol (SIP), Media Gateway Control Protocol (MGCP) and H.248, can hardly traverse a conventional NAT or FW device to communication with public networks. In other words, most of the conventional NAT or FW devices just support services based on a data application protocol of Hyper Text Transfer Protocol (HTTP), do not support session-based services in traversing. Therefore, it comes to be an urgent issue to enable services based on a private network address to traverse the NAT or the FW device, and the issue has been the greatest challenge for implementing the NGN network services at present.

An Application Level Gateway (ALG) is used in the conventional method for traversing the NAT or the FW device. The ALG is a device which can recognize designated IP protocols (for example H.323, SIP or MGCP). The ALG can be a standalone device between a public network and a private network, or an embedded part in the NAT or FW device. The ALG communicates with the NAT or FW device to establish NAT or FW device status information and alters specific data encapsulated in the data fields of IP packets by using the NAT or FW device status information, and enables the IP packets to traverse the NAT or FW device via other necessary processes.

A large number of conventional NAT or FW devices do not support the ALG scheme, hence the ALG scheme can only be adopted when the NAT or FW devices are replaced or upgraded. Users generally expect operators to provide new conversational services over IP without changing the existing NAT or FW devices. Therefore, the ALG scheme is unable to achieve the objective of traversing the NAT or FW devices without modifying the NAT or FW devices.

### SUMMARY

In view of the above problem in the prior art, embodiments of the present invention intend to provide a method and system for traversing NAT or FW devices without modifying the NAT or FW devices.

The schemes of the present invention is achieved with the following technical scheme:

setting up a User Datagram Protocol (UDP) tunnel between a first device and a second device, wherein the first device and the second device are on the two sides of an NAT or a FW device; and

transmitting, via the UDP tunnel, a packet originated from one of the two devices to the other of the two devices through the NAT or FW device.

A system for implementing an NAT or FW device traverse includes a first device, a second device and an NAT or FW device, wherein a UDP tunnel is set up between the first device and the second device; wherein

the second device is configured to transmit a packet to the NAT or FW device via the UDP tunnel;

the NAT or FW device is configured to forward the packet to the first device; and

the first device is configured to receive the packet.

It can be seen from a comparison between the scheme provided by the present invention and the conventional scheme that the NAT or FW device traversal is achieved by establishment of a UDP tunnel between two devices, and use of the UDP tunnel for traversing the NAT or FW device. The present invention enables packets of H.323, SIP, MGCP and H.248 services to traverse the NAT or FW device without modifying the NAT or FW device. With the scheme provided by the present invention, the security of the existing network may not be affected, and the security and QoS of the existing services in the network may not be affected either.

### BRIEF DESCRIPTION OF THE DRAWINGS

FIG. 1 is a schematic diagram illustrating a system for implementing an NAT or FW device traverse according to an embodiment of the present invention.

FIG. 2 is a simplified flow chart of transmitting a packet by a terminal to a server via a UTC and a UTS according to the first embodiment of the present invention.

FIG. 3 is a schematic diagram illustrating the process of inserting a UTH by a UTC behind an IP header of a packet from a terminal according to the first embodiment of the present invention.

FIG. 4 is a simplified flow chart of transmitting a packet from a server to a terminal via a UTS and a UTC according to the first embodiment of the present invention.

FIG. 5 is a simplified flow chart of transmitting a packet from a terminal to a server via a UTC and a UTS according to the second embodiment of the present invention.

FIG. 6 is a schematic diagram illustrating the data in a UTH transmitted in a process of transmitting data between a terminal and a server according to the present invention.

### DETAILED DESCRIPTION OF THE INVENTION

The present invention provides a method for traversing an NAT or FW device. The present invention includes deploying a UDP Tunnel Client (UTC) and a UDP Tunnel Server (UTS) between two devices which are on the two sides of an NAT or FW device separately, setting up a UDP tunnel between the two devices through which a packet may traverse the NAT or FW device. In the present invention, the UTC can be deployed on one side of the NAT or FW device while the UTS can be deployed on another side of the NAT or FW device; alternatively, the UTC may be deployed on one side of the NAT or FW device while the UTS may be deployed in the NAT or FW device. In embodiments provided as follows, the UTC is deployed on one side of the NAT or FW device and the UTS is deployed on the other side of the NAT/FW device. It is known to those skilled in the art that the NAT/FW device represents an NAT or FW device.

According to the present invention, first of all, the UTC is deployed on one side of the NAT or FW device while the UTS is deployed on the other side of the NAT or FW device. The UTC or UTS can be a standalone device or an embedded part of any device such as a proxy device, an NAT device, a firewall device, a router or a server. The two devices capable of implementing the NAT or FW device traverse may be any two network devices, such as a terminal and a server, two terminals, two servers and two routers.

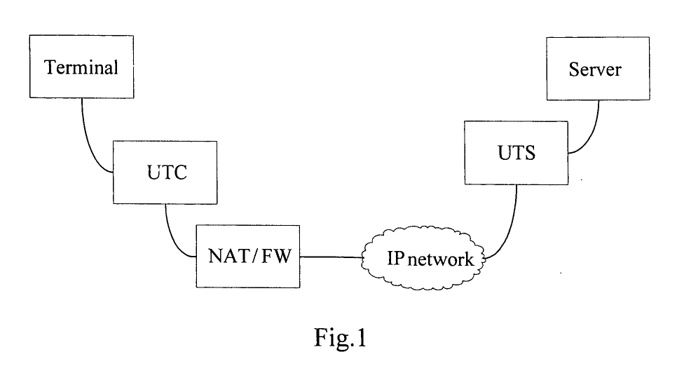

FIG. 1 is a schematic diagram illustrating a system for implementing an NAT or FW device traverse according to an embodiment of the present invention. In the network shown in FIG. 1, the UTC is deployed on the terminal side and the UTS is deployed on the server side. With the method provided by the present invention, a UDP tunnel is set up between the terminal and the server, and all packets to-be-transmitted between the terminal and the server are transmitted via the UDP tunnel once the UDP tunnel is set up.

In the network shown in FIG. 1, the packets to-be-transmitted include the packets from the terminal to the server via the UTC and the UTS and the packets from the server to the terminal via the UTC and the UTS. For the former, the terminal functions as a packet transmitter and the server functions as a packet receiver, and for the latter, the server functions as the packet transmitter and the terminal functions as the packet receiver. The UDP tunnel is set up during the procedure of sending a packet from the terminal to the server.

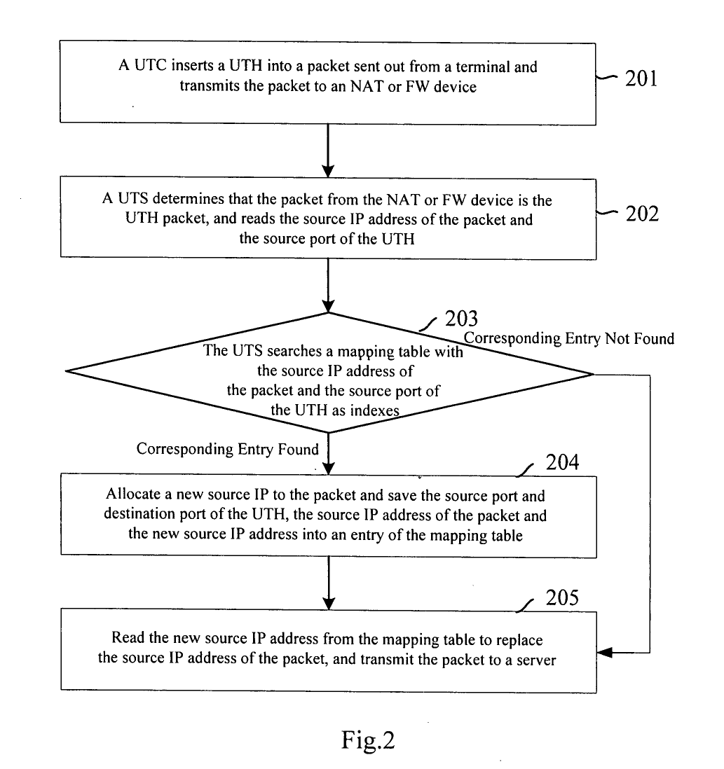

The first embodiment of the present invention is described hereinafter in accordance with the accompanying drawings. FIG. 2 is a simplified flow chart of transmitting a packet from a terminal to a server via a UTC and a UTS according to the first embodiment of the present invention. Operations performed by the UTC and the UTS on a packet are described in the following flow chart, which includes the following processes.

In block 201, the UTC inserts a UDP tunnel header (UTH) into the packet sent from the terminal, and transmits the packet to an NAT or FW device.

Upon the receipt of the packet sent from the terminal, the UTC inserts the UTH into the packet behind the IP header of the packet.

The UTH mainly includes:

a standard UDP header, mandatory.

a protocol field, mandatory. The protocol field is behind the standard UDP header, and used for indicating the type of the packet borne in the source IP packet, for example the packet is a UDP packet, a Transfer Control Protocol (TCP) packet, or a Stream Control Transfer Protocol (SCTP) packet.

a type field, optional. The type field is behind the standard UDP header, and used for indicating the type of the packet of the UDP tunnel itself.

Upon the receipt of the packet, the UTC inserts the UTH behind the IP header of the packet sent from the terminal. The protocol field in the UTH is identical with the protocol field in the IP header of the packet. The UTC recalculates the checksum of the packet and transmits the packet to the NAT or FW device which transmits the packet to the UTS upon the receipt of the packet.

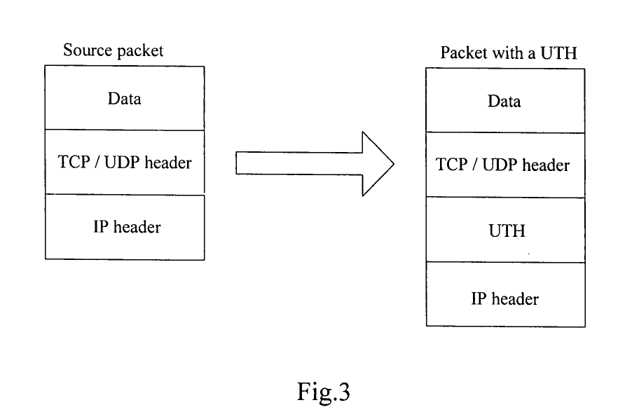

FIG. 3 is a schematic diagram illustrating the process of inserting the UTH behind the IP header of the packet sent from the terminal by the UTC. As shown in FIG. 3, the original packet includes the IP header, the TCP or UDP header and data. In block 201, the UTC inserts the UTH into the packet to form the packet as shown in FIG. 3.

In block 202, the UTS determines that the packet from the NAT or FW device is a UDP tunnel packet, and reads the source IP address of the packet and source port of the UTH from the packet.

Upon receipt of the packet from the NAT or FW device, the UTS judges whether the packet is the UDP tunnel packet by checking whether the packet includes the UTH. If the packet includes the UTH, the UTS reads the source IP address of the packet and the source port of the UTH and proceeds to block 203; otherwise the UTS processes the packet according to common packet processing procedure used in a conventional method and terminates the process.

In block 203, the UTS searches for a mapping table with the source IP address of the packet and the source port of the UTH as indexes.

Generally, all UDP tunnel packets from the same UTC have a same source port and destination port of the UTH. In the embodiment, the UTS keeps at mapping table in which each entry includes a quadriad of information fields, i.e., the source port and the destination port of the UTH, the source IP address of the packet and a newly-allocated source IP address, and each entry indicates a UDP tunnel between the UTC and the UTS.

The UTS searches for the mapping table with the source IP address of the packet and the source port of the UTH read from the packet as indexes. If no corresponding entry is found, block 204 is performed. If a corresponding entry is found, which means the UDP tunnel corresponding to the source IP address of the packet has been set up between the UTS and the UTC and the packet can be transmitted via the UDP tunnel directly, block 205 is performed.

In block 204, the UTS allocates a new source IP address to the packet, and saves the source port and the destination port of the UTH, the source IP address of the packet and the new source IP address into the mapping table.

If no corresponding entry is found in block 203, it means no UDP tunnel corresponding to the source IP address of the packet is set up between the UTS and the UTC. Then, the UTS allocates a new source IP address to the packet and saves the source port and the destination port of the UTH, the source IP address of the packet and the new source IP address into a new entry of the mapping table. Therefore, the UDP tunnel corresponding to the source IP address of the packet is set up between the UTS and the UTC.

In block 205, the UTS replaces the source IP address of the packet with the new source IP address read from the corresponding entry of the mapping table, and transmits the processed packet to the server.

In this process, the UTS reads the new source IP address from the corresponding entry of the mapping table and replaces the source IP address of the packet with the new source IP address. Afterwards, the UTS removes the UTH of the packet, recalculates the checksum of the packet and transmits the packet to the server.

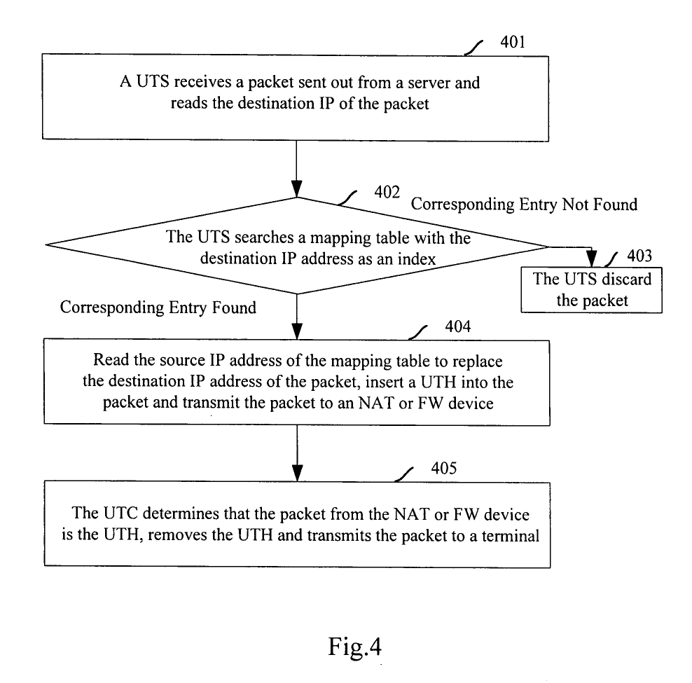

FIG. 4 is a simplified flow chart of transmitting a packet by a server to a terminal via a UTS and a UTC according to the first embodiment of the present invention. Operations performed by the UTC and the UTS on a packet are described in the following flow chart which includes the following processes.

In block 401, upon the receipt of a packet sent from a server, the UTS reads the destination IP address of the packet.

In block 402, the UTS searches for a mapping table with the destination IP address as an index.

The UTS searches for the mapping table saved in the UTS with the destination IP address as the index. If a corresponding entry is found in the mapping table in which a new source IP address is identical with the destination IP address of the packet, block 404 is performed; otherwise block 403 is performed.

In block 403, the UTS ignores the packet.

If no corresponding entry is found in the mapping table which indicates that the packet should not be processed by the UTS, the UTS ignores the packet directly and terminates the process.

In block 404, the UTS replaces the destination IP address in the packet with the source IP address of the packet saved in the mapping table, inserts a UTH into the packet and transmits the packet to an NAT or FW device.

If a corresponding entry is found in the mapping table which indicates that the packet should be processed by the UTS and a corresponding UDP channel has been set up. The source IP address of the packet in the entry is read to replace the destination IP address and a UTH is inserted into the packet behind the IP header of the packet. The destination port of the UTH is the source port of the UTH in the entry and the source port of the UTH is the destination port of the UTH in the entry. The protocol field of the UTH is identical with the protocol field of the original IP header. The value of the protocol field in the new IP header is updated to 17, which indicates the port number of UDP protocol. The UTS recalculates the checksum of the packet and transmits the packet to the NAT or FW device which transmits the packet to the UTC upon the receipt of the packet.

In block 405, the UTC determines that the packet sent from the NAT or FW device is a UDP tunnel packet, removes the UTH from the packet and transmits the packet to the terminal.

Upon the receipt of the packet sent from the NAT or FW device, the UTC determines whether the packet is the UDP tunnel packet according to whether the packet includes the UTH. If the packet includes the UTH, the UTC removes the UTH and transmits the packet to the terminal according to the destination IP address in the packet; otherwise, the UTC processes the packet according to a common packet processing procedure used in a conventional.

If there are no adequate IP addresses for a UTS to allocate, the second embodiment of the present invention provides another scheme. In the embodiment, a UTC processes a packet in the same manner as in the first embodiment while the UTS adopts a different procedure. For example, the UTS allocates an IP address and a port to the packet.

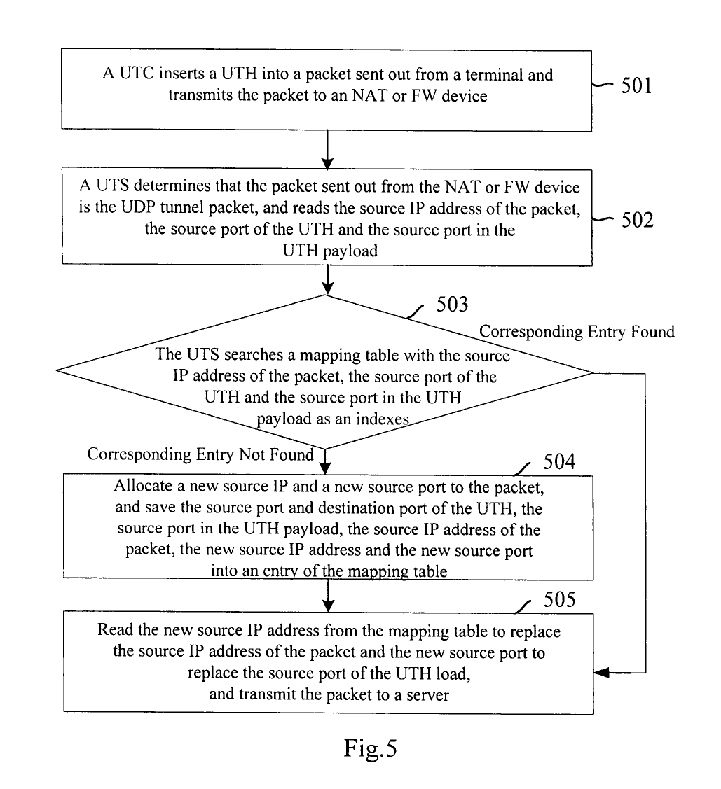

FIG. 5 is a simplified flow chart of transmitting a packet by a terminal to a server via a UTC and a UTS according to the second embodiment of the present invention. Operations performed by the UTC and the UTS on a packet are described in the following flow chart, which includes the following processes.

In block 501, the UTC inserts a UTH into a packet sent from the terminal, and transmits the packet to an NAT or FW device.

In this block, similar to block 201, the UTC inserts the UTH into the packet sent from the terminal behind the IP header upon the receipt of the packet. The protocol field in the UTH is identical with the protocol field in the original IP header of the packet. The UTC recalculates the checksum of the packet and transmits the packet to the NAT or FW device which transmits the packet to the UTS upon the receipt of the packet.

In block 502, the UTS determines that the packet sent from the NAT or FW device is a UDP tunnel packet and reads the source IP address of the packet, the source port of the UTH and the source port in the UTH payload.

Upon the receipt of the packet sent from the NAT or FW device, the UTS judges whether the packet is the UDP tunnel packet by checking whether the packet includes the UTH. If the packet includes the UTH, the UTS reads the source IP of the packet, the source port of the UTH and the source port in the UTH payload and proceeds to block 503; otherwise the UTS processes the packet according to a common packet processing procedure used in a conventional method and terminates the process.

In block 503, the UTS searches for a mapping table with the source IP of the packet, the source port of the UTH and the source port in the UTH payload as indexes.

Unlike the procedure of searching for the mapping table in block 203, in the embodiment, the UTS keeps the mapping table in which each entry includes a hexad of information fields, i.e., the source port and the destination port of the UTH, the source port in the UTH payload, the source IP address of the packet, a new source IP address and a new source port, and each entry indicates a UDP tunnel between the UTC and the UTS.

The UTS searches for the mapping table with the source IP address of the packet, the source port of the UTH and the source port in the UTH payload as indexes. If no corresponding entry is found, block 504 is performed. If a corresponding entry is found, which means the corresponding UDP tunnel has been set up and the packet can be transmitted via the UDP tunnel directly, block 505 is performed.

In block 504, the UTS allocates a new source IP address and a new source port to the packet, and saves the source port and the destination port of the UTH, the source port in the UTH payload, the source IP address of the packet, the new source IP address and the new source port into the mapping table.

The UTS searches for the mapping table with the source IP address of the packet, and the source port of the UTH and the source port in the UTH payload as indexes. If no corresponding entry is found, which indicates the UDP tunnel corresponding to the source IP address of the packet has not been set up between the UTS and the UTC, the UTS allocates the new source IP address and new source port to the packet, and saves the source port and the destination port of the UTH, the source port in the UTH payload, the source IP address of the packet, the new source IP address and new source port into a new entry of the mapping table. Thus, the UDP tunnel corresponding to the source IP address of the packet is set up between the UTS and the UTC.

In block 505, the UTS replaces the source IP address of the packet with the new source IP address and the source port in the UTH payload with the new source port, and transmits the packet to the server.

The UTS reads the new source IP address and the new source port from a corresponding entry of the mapping table, and replaces the source IP address of the packet with the new source IP address and the source port in the UTH payload with the new source port. The UTS removes the UTH in the packet, recalculates the checksum of the packet and transmits the packet to the server.

In the second embodiment, the process of transmitting packet from the server to the terminal via the UTS and the UTC is very similar to the corresponding process in the first embodiment and will not be described repeatedly.

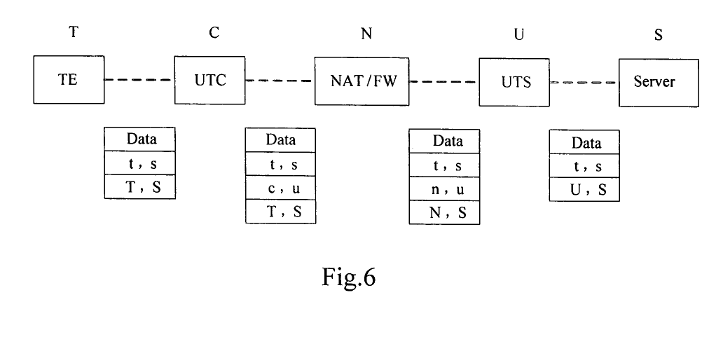

FIG. 6 is a structure diagram illustrating the data carried in a UTH transmitted during the procedure of the data transmission between the server and the terminal according to the first embodiment and the second embodiment. The UTH is transmitted between two devices. FIG. 6 shows the information of the devices carried in the UTH. In FIG. 6, T and TE stand for the terminals, C stands for the UTC, N stands for the NAT or FW device, U stands for the UTS, S and Server stand for the servers. The “t, s” indicates the source port and the destination port in the UTH payload, the “T, S” indicates that the source IP address of the packet, i.e., the IP address of the terminal and the destination IP address of the packet, i.e., the IP address of the server. The “c, u” indicates the source port and the destination port of the UTH, and the “n, u” indicates the source port and the destination port after the procession of the NAT.

In the second embodiment, similar to the first embodiment, the UTC or UTS can be a standalone device or an embedded part of any device, such as a proxy device, an NAT device, a firewall, a router and a server.

When the UTS is embedded in a proxy device, functions of the UTS can be combined with the conventional functions of the proxy device, that is to say, the proxy device alters the destination IP address of the packet and further implements the operations described in the two embodiments.

When the UTS is embedded in the NAT or FW device, functions of the UTS can be combined with the conventional functions of the NAT or FW device, that is to say, the NAT or FW device alters the destination IP address of the packet and further implements the operations described in the two embodiments.

It should be emphasized that the above embodiments, particularly, any preferred embodiment, are merely possible examples of implementation, merely set forth for a clear understanding of the principles of the invention. Many variations and modifications may be made to the above preferred embodiments without departing substantially from the spirit and principles of the invention. All such modifications and variations are intended to be included within the scope of this disclosure and the above preferred embodiments and protected by the following claims.

1. A method for traversing a Network Address Translation, NAT, or Firewall, FW, device, comprising:
setting up a User Datagram Protocol, UDP, tunnel between a first device and a second device, wherein the first device and the second device are on the two sides of an NAT or FW device; and
transmitting, via the UDP tunnel, a packet originated from one of the two devices, to the other of the two devices through the NAT or FW device.

2. The method of claim 1, further comprising:
deploying a UDP Tunnel Client, UTC, and a UDP Tunnel Server, UTS, between the first device and the second device;
wherein setting up the UDP tunnel comprises:
setting up the UDP tunnel between the first device and the second device with the UTC and the UTS.

3. The method of claim 2, wherein the setting up the UDP tunnel with the UTC and the UTS comprises:
receiving, by the UTC, a packet originated from the first device, and inserting, by the UTC, a UDP tunnel header, UTH, behind the Internet Protocol, IP, header of the packet originated from the first device; and
receiving, by the UTS, the packet sent from the UTC via the NAT or FW device, allocating, by the UTS, a new source IP address to the packet, generating, by the UTS, UDP tunnel information including the source port and destination port of the UTH, the source IP address of the packet sent from the UTC and the new source IP address allocated for the packet sent from the UTC.

4. The method of claim 3, wherein transmitting the packet originated from the first device to the second device comprises:
replacing, by the UTS, the source IP address of the packet sent from the UTC with the new source IP address, removing, by the UTS, the UTH, and transmitting, by the UTS, the packet sent from the UTC to the second device.

5. The method of claim 3, upon receiving the packet sent from the UTC via the NAT or FW device, further comprising:
searching, by the UTS, with the source IP address of the packet sent from the UTC and the source port of the UTH as indexes and allocating, by the UTS, a new source IP address to the packet sent from the UTC if the UDP tunnel information is not found.

6. The method of claim 2, wherein the setting up the UDP tunnel with the UTC and the UTS comprises:
receiving, by the UTC, a packet originated from the first device and inserting, by the UTC, a UTH behind the IP header of the packet originated from the first device; and
receiving, by the UTS, the packet sent from the UTC via the NAT or FW device, allocating, by the UTS, a new source IP address and a new source port to the packet sent from the UTC, and generating, by the UTS, UDP information by using the source port and the destination port of the UTH, the source port in the UTH payload, the source IP address of the packet sent from the UTC, the new source IP address and the new source port in the packet sent from the UTC.

7. The method of claim 6, wherein transmitting the packet originated from the first device to the second device comprises:
replacing, by the UTS, the source IP address of the packet sent from the UTC with the new source IP address and the source port in the UTH payload with the new source port, and removing, by the UTS, the UTH, and transmitting, by the UTS, the packet sent from the UTC to the second device.

8. The method of claim 6, upon receiving the packet sent from the UTC via NAT or FW device, further comprising:
searching, by the UTS, with the source IP address of the packet sent from the UTC, the source port of the UTH and the source port in the UTH payload as indexes and allocating, by the UTS, a new source IP address and a new source port to the packet sent from the UTC if the UDP tunnel information is not found.

9. The method of claim 2, wherein tramsmitting the packet originated from the second device via the UDP tunnel to the first device comprises:
searching, by the UTS, with the destination IP address of the packet originated from the second device as an index upon the receipt of the packet originated from the second device, ignoring the packet originated from the second device, and terminating the process if the UDP tunnel is not found; otherwise,
replacing, by the UTS, the destination IP address of the packet originated from the second device with the source IP address in the UDP tunnel information and inserting, by the UTS, behind the IP header of the packet originated from the second device, a UTH taking the source port of the UTH in the UDP tunnel information as the destination port and the destination port of the UTH in the UDP tunnel information as the source port; and
receiving, by the UTC, the packet sent from the UTS via the NAT or FW device, removing, by the UTC, the UTH in the packet sent from the UTS, and transmitting, by the UTC, the packet sent from the UTS to the first device.

10. The method of claim 3, wherein the UTH comprises a standard UDP header and a protocol field for indicating the type of the packet borne in the original packet.

11. The method of claim 10, wherein the UTH further comprises a type field for indicating the type of the UDP tunnel packet.

12. A system for implementing an NAT or FW device traverse, comprising a first device, a second device and an NAT or FW device, wherein a UDP tunnel is set up between the first device and the second device; wherein
the second device is configured to transmit a packet to the NAT or FW device via the UDP tunnel;
the NAT or FW device is configured to forward the packet to the first device; and
the first device is configured to receive the packet.

13. The system of claim 12, further comprising:
a UTC, configured to receive a packet originated from the first device and insert a UTH behind the IP header of the packet originated from the first device; and
a UTS, configured to receive the packet sent from the UTC via the NAT or FW device, allocate a new source IP address to the packet sent from the UTC, and generate UDP tunnel information comprising the source port and destination port of the UTH, the source IP address of the packet sent from the UTC and the new source IP address in the packet sent from the UTC.

14. The system of claim of 12, further comprising:
a UTC, configured to receive a packet originated from the first device and insert a UTH behind the IP header of the packet originated from the first device; and
a UTS, configured to receive the packet sent from the UTC via the NAT or FW device, allocate a new source IP address and a new source port to the packet sent from the UTC, and generate UDP information including the source port and the destination port of the UTH, the source port in the UTH payload, the source IP address of the packet sent from the UTC, the new source IP address and the new source port in the packet sent from the UTC.

15. The system of claim 13, wherein the UTC is a standalone device or an embedded part in a proxy device, an NAT device, a firewall, a router or a server;
the UTS is a standalone device or an embedded part in a proxy device, an NAT device, a firewall, a router or a server;
the UTC is on one side of the NAT or FW device and the UTS is on the other side of the NAT or FW device; or
the UTC is on one side of the NAT or FW device and the UTS is in the NAT or FW device.

16. The system of claim 12, wherein the NAT or FW device is an NAT or FW device in Next Generation Network, NGN.
